(19) United States
(12) Patent Application Publication
(10) Pub. No.: US 2025/0070517 A1
(43) Pub. Date: Feb. 27, 2025

(54) ELECTRICAL CONNECTOR CONTACT ASSEMBLY HAVING UPPER AND LOWER GROUND PLATES SURROUNDING A ROW OF CONTACTS

(71) Applicants: FOXCONN (KUNSHAN) COMPUTER CONNECTOR CO., LTD., Kunshan (CN); FOXCONN INTERCONNECT TECHNOLOGY LIMITED, Grand Cayman (KY)

(72) Inventors: PATRICK R. CASHER, North Aurora, IL (US); TERRANCE F. LITTLE, Fullerton, CA (US); CHUN-HSIUNG HSU, New Taipei (TW); YI-MIN HSU, New Taipei (TW); MING ZHOU, Kunshan (CN)

(21) Appl. No.: 18/808,368

(22) Filed: Aug. 19, 2024

Related U.S. Application Data
(60) Provisional application No. 63/520,911, filed on Aug. 21, 2023.

(51) Int. Cl. H01R 13/6581; H01R 4/06; H01R 13/405

(52) U.S. Cl. CPC H01R 13/6581; H01R 4/06; H01R 13/405

(57) ABSTRACT

A contact assembly for an electrical connector, includes: a row of contacts having plural contacting portions; an insulator secured to the contacting portions; an upper ground plate and a lower ground plate surrounding the row of contacts, at least one of the upper and lower ground plates integrally having plural ground contacting portions aligned with the contacting portions of the row of contacts; and plural separate conductive rivets electrically connecting the upper and lower ground plates.

### CROSS REFERENCE TO RELATED APPLICATION

This application claims priority to and benefit of U.S. Provisional Patent Application No. 63/520,911, filed Aug. 21, 2023.

### BACKGROUND OF THE INVENTION

### Field of the Invention

The present invention relates to a contact assembly for an electrical connector comprising: a row of contacts having a plurality of contacting portions; an insulator secured to the plurality of contacting portions; an upper ground plate and a lower ground plate surrounding the row of contacts, at least one of the upper and lower ground plates integrally having a plurality of ground contacting portions aligned with the plurality of contacting portions of the row of contacts; and a conductive element electrically connecting the upper and lower ground plates.

### Description of Related Arts

U.S. Patent Application Publication No. 2021/0328384 discloses a conductive ground shield which may be plural split-shields or a single piece. Also disclosed is combining the conductive ground shield and metal ground conductors, as seen in drawing FIG. 3L thereof.

U.S. Patent Application Publication No. 2022/0352675 discloses a lead frame assembly having corrugated sheet or sheets. The corrugated sheets may be provided on a top surface, a bottom surface, or both the top and bottom surfaces of the lead frame assembly. The corrugated sheet electrically couples ground conductors and may be made of material that is electrically conductive or lossy. Electrically lossy materials typically have a bulk conductivity of about 1 to 100,000 Siemen/meter.

U.S. Pat. No. 11,322,869 discloses a contact assembly for an electrical connector, comprising: a contact array including signal contacts and ground contacts having mating beams and tails; a front contact holder holding the mating beams and a rear contact holder holding the tails; and a ground bus bridge extending between each of the ground contacts to electrically common each of the ground contacts. The ground bus bridge is integral with the ground contacts and includes a plate at ground intermediate portions. The plate of the ground bus bridge extends across signal intermediate portions, i.e., parallel thereto, spaced apart therefrom, and in close proximity thereto, for resonance control of signals transmitted along the signal contacts.

U.S. Pat. No. 11,469,554 discloses a leadframe assembly including conductive elements, a leadframe housing holding the conductive elements, and a ground shield separate from intermediate portions of the conductive elements by the leadframe housing. The ground shield may be stamped from a sheet of metal and may have a right angle bend. The ground shield may be attached to housing portions. The ground shield may include a body, ground mating ends extending from the body, and ground mounting ends also extending from the body.

U.S. Patent Application Publication No. 2014/0127946 discloses a receptacle connector including a housing, plural first row contacts, plural second row contacts, plural first conductive members, and plural second conductive members. The conductive members are made of a conductive resin for electrically connecting plural ground contacts of the row of contacts. The conductive member has a base portion and a projection. The conductive members may be connected to each other, i.e., integrated together, when a long and thin metal plate is inserted thereinto, so as to have flexibility in handling.

### SUMMARY OF THE INVENTION

A contact assembly for an electrical connector, comprises: a row of contacts having a plurality of contacting portions; an insulator secured to the plurality of contacting portions; an upper ground plate and a lower ground plate surrounding the row of contacts, at least one of the upper and lower ground plates integrally having a plurality of ground contacting portions aligned with the plurality of contacting portions of the row of contacts; and a plurality of separate conductive rivets electrically connecting the upper and lower ground plates.

### BRIEF DESCRIPTION OF DRAWINGS

FIG. 1 is a perspective view of an electrical connector incorporating a contact assembly in accordance with the present invention;

FIG. 2 is a rear view of the electrical connector;

FIG. 3 is an exploded view of the electrical connector;

FIG. 4 is a view similar to FIG. 3 but from another perspective;

FIG. 5 is a perspective view of the contact assembly;

FIG. 6 is a view similar to FIG. 5 but from another perspective;

FIG. 7 is a side view of FIG. 5;

FIG. 8 is a cross-sectional view of the contact assembly taken along line 8-8 in FIG. 5;

FIG. 9 is a cross-sectional view of the contact assembly taken along line 9-9 in FIG. 5;

FIG. 10 is an exploded view of the contact assembly;

FIG. 11 is a view similar to FIG. 10 but from another perspective;

FIG. 12 is a perspective view of an upper assembly of the contact assembly;

FIG. 13 is an exploded view of the upper assembly;

FIG. 14 is a further exploded view of FIG. 13;

FIG. 15 is a view similar to FIG. 14 but from another perspective;

FIG. 16 is a perspective view of a plurality of conductive plastic rivets;

FIG. 17 is an exploded view of the conductive plastic rivets;

FIG. 18 is a side view of a varied contact assembly;

FIG. 19 is an exploded view of an upper assembly of the varied contact assembly;

FIG. 20 is an exploded view of a lower assembly of the varied contact assembly;

FIG. 21 depicts varied conductive plastic rivets used in a contact assembly shown in part;

FIG. 22 shows a cross-sectional view of the contact assembly in FIG. 21; and

FIG. 23 is an exploded view of the contact assembly in FIG. 21.

### DETAILED DESCRIPTION OF THE DRAWINGS

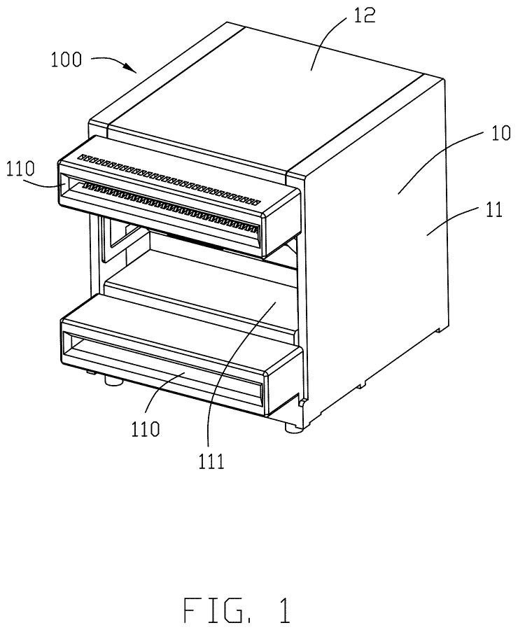

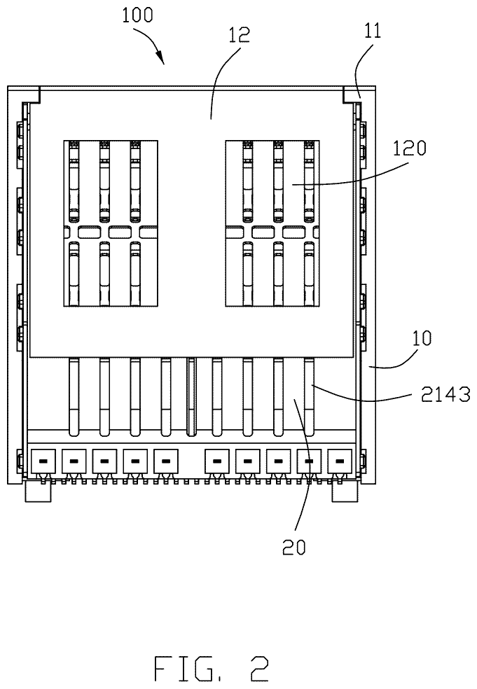

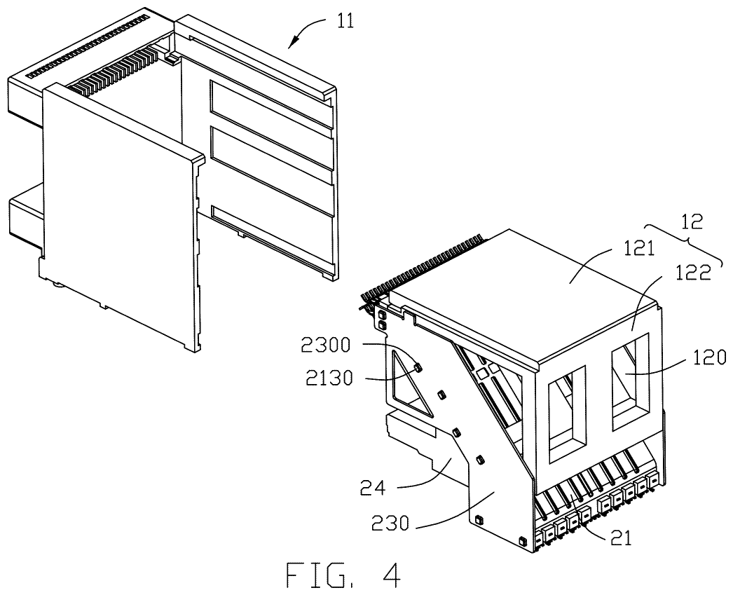

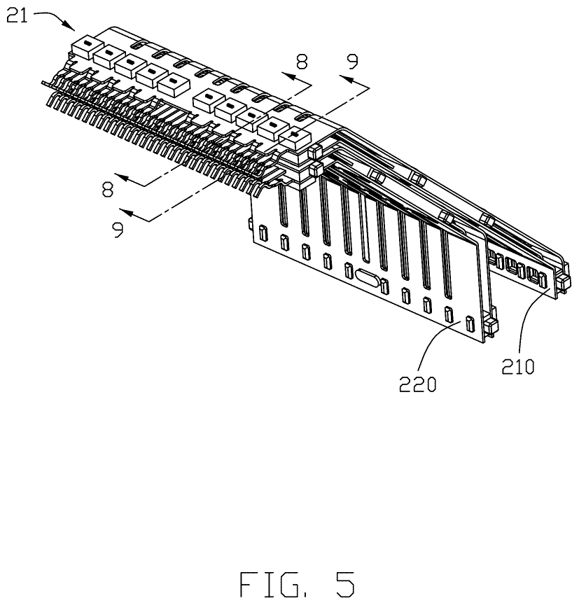

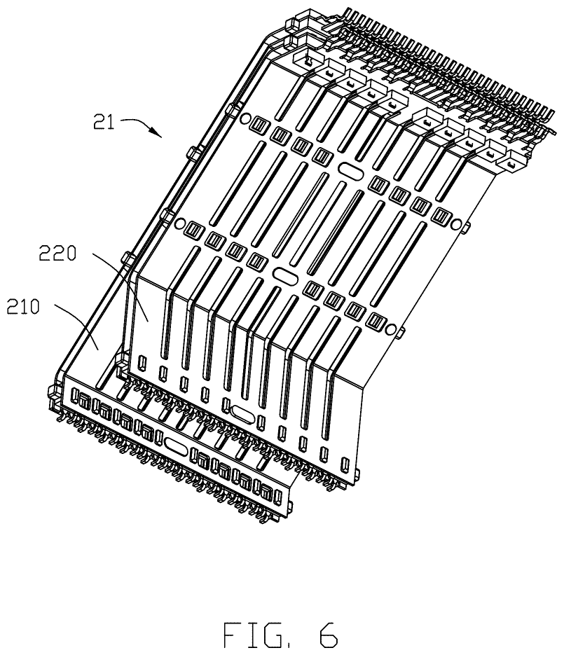

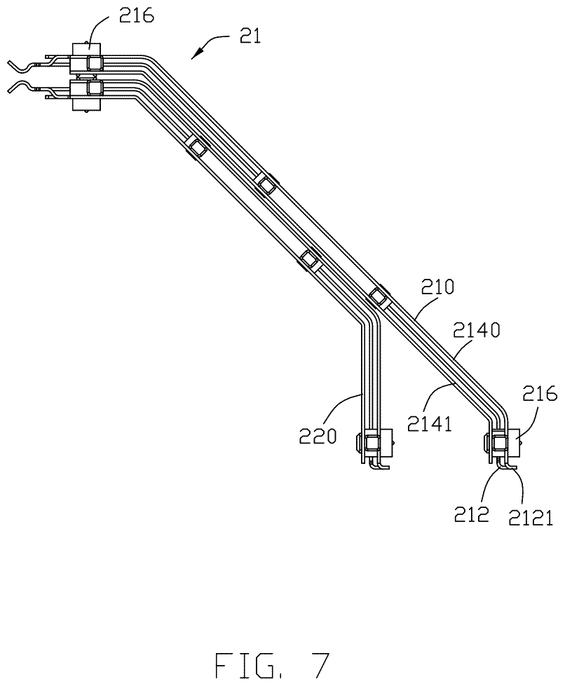

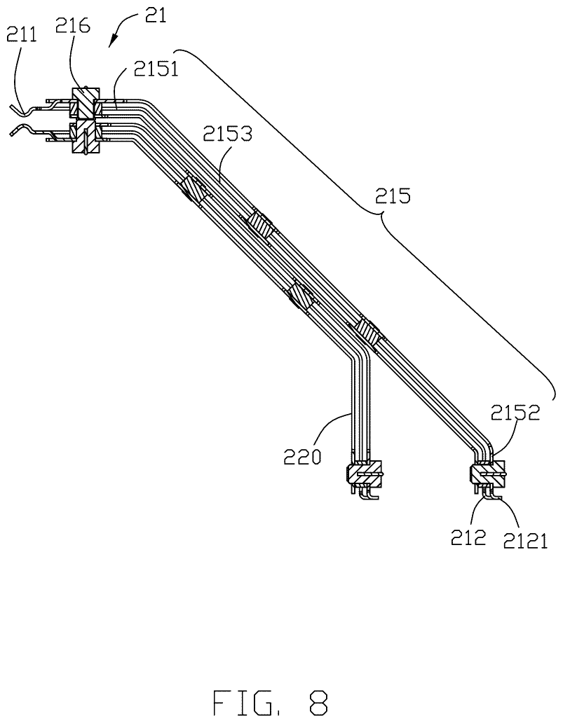

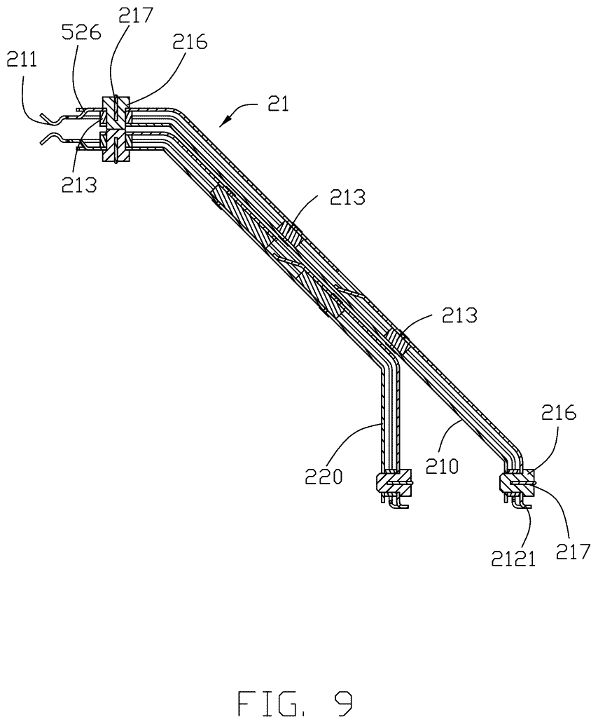

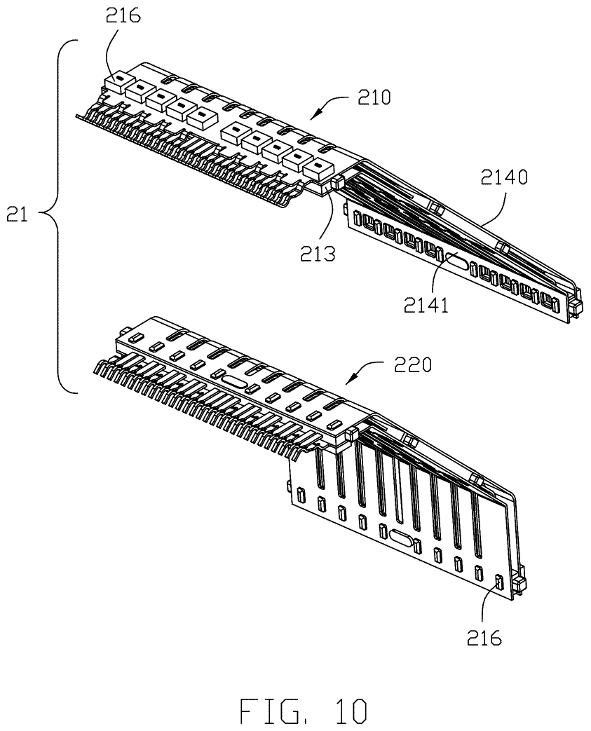

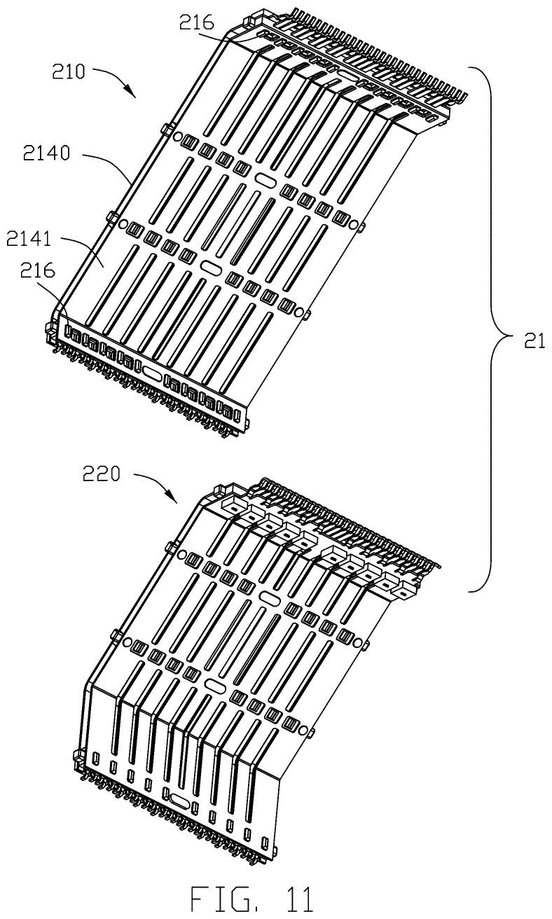

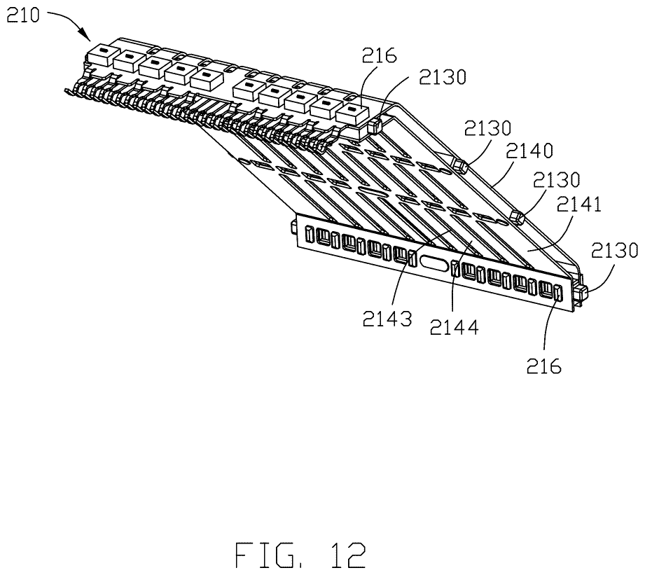

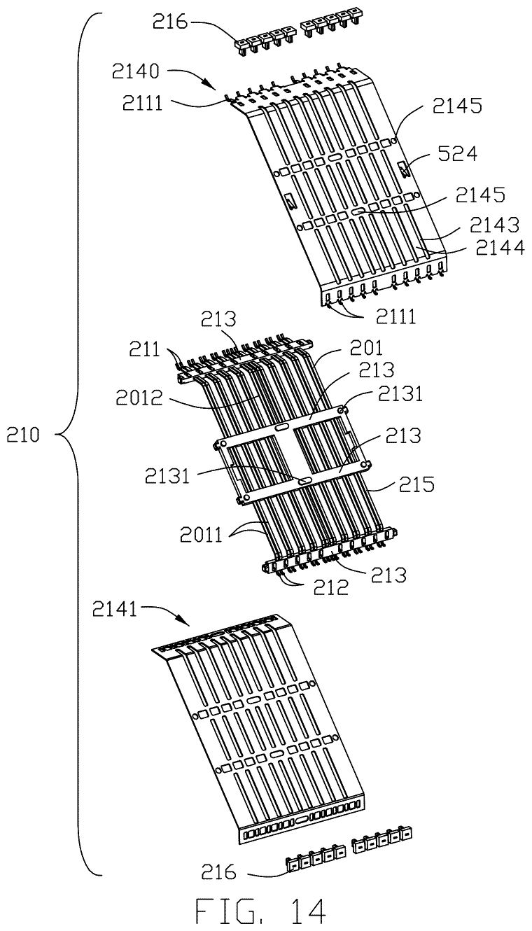

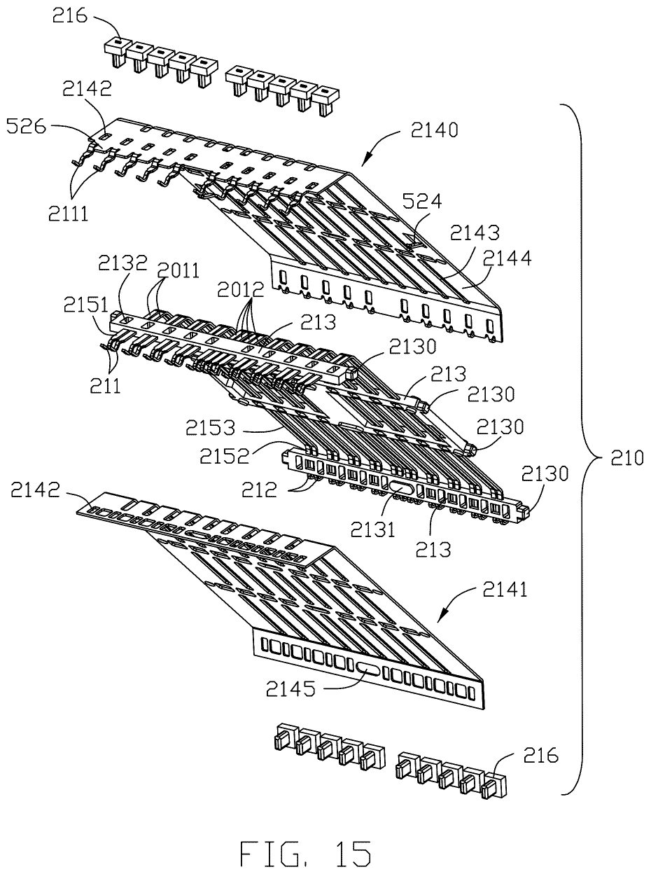

Referring to FIGS. 1-17, an electrical connector 100 comprises an insulative housing 10 and a contact module 20 in the insulative housing 10. The insulative housing 10 includes a main body 11 and a cover 12. The main body 11 has upper and lower mating ports 110 and an intermediate opening 111 therebetween. The cover 12 has a top portion 121 and a rear portion 122. The rear portion 122 has openings 120.

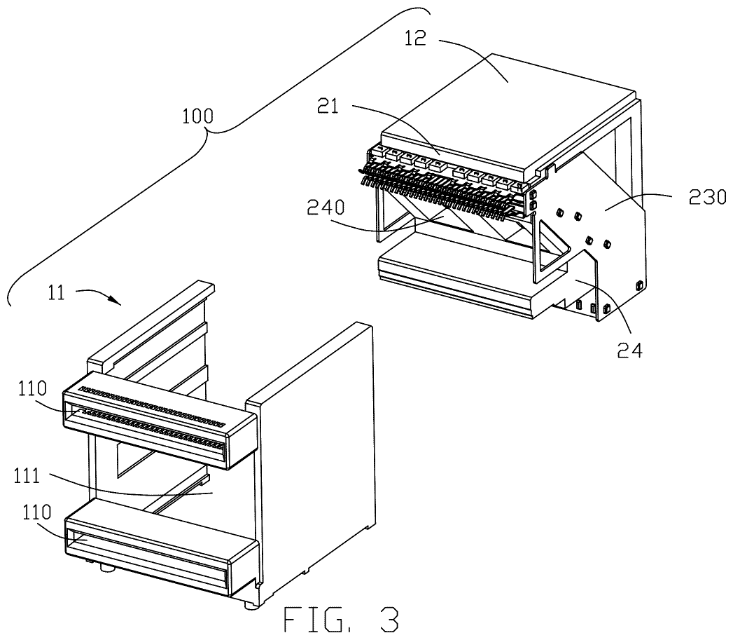

Referring specifically to FIGS. 3-12, the contact module 20 in the embodiment shown includes an upper unit 21, a lower unit, and a separator 24 therebetween. The upper unit 21 includes an upper assembly 210, a lower assembly 220, and a pair of side plates 230 for assembling the upper and lower assemblies 210 and 220. The upper assembly 210 and the lower assembly 220 together form a mating area and are electrically connected to two opposite surfaces of the mating connector. The separator 24 has plural openings 240 for circulation of air. The side plate 230 combines the upper and lower assemblies 210 and 220 and the cover 12 together to assembled into the main body 11

The upper assembly 210 includes a row of contacts 201, an insulator 213 secured to the row of contacts 201, an upper ground plate 2140 and a lower ground plate 2141 that surround the row of contacts 201, and a conductive element 216 electrically connecting the upper and lower ground plates 2140 and 2141. The insulator 213 is integrally formed on the first row of contacts 201 via insert molding. The row of contacts 201 includes signal contacts 2011 for differential pair signals and side-band contacts 2012 for ground signals for control, power, and low-speed signals. In this embodiment, in the upper assembly 210, there are four side-band contacts 2012 set in the middle area, and eight pairs of signal contacts 2011 corresponding to eight high-speed signal channels. The eight pairs of signal contacts 2011 are divided into two groups and are arranged on two sides of the middle area. Of course, the number of high-speed signal channels can be any number greater than or equal to one. The number of low-speed signals, power supply, control and other signal channels can also be increased or decreased, or even not provided. Each of the row contacts 201 has a contacting portion 211, a mounting portion 212, and an intermediate portion 215 between the contacting portion 211 and the mounting portion 212. The intermediate portion 215 includes a horizontal section 2151 connected to the contacting portion 211, a vertical section 2152 connected to the mounting portion 212, and an inclined section 2153 between the horizontal section 2151 and the vertical section 2152.

The upper ground plate 2140 and the lower ground plate 2141 equidistantly spaced from and surround the row of contacts 201 to form a strip-line structure for achieving a better high speed transmission performance, like a PCB style design.

Each of the upper ground plate 2140 and the lower ground plate 2141 is generally planar and may be a single piece or be constructed of multiple pieces. To have a better shielding effect, the upper ground plate 2140 and the lower ground plate 2141 in the lateral direction is greater than or equal to the outermost dimension of the first row of contacts 201 in the lateral direction. The upper ground plate 2140 and the lower ground plate 2141 are spaced apart from the row of contacts 201 through the insulator 213. Therefore, the row of contacts 201 are exposed to the air except for the parts formed on the insulator 213. Each ground plate 2140 or 2141 has a plurality of openings 2143 for air circulation and plural portions 2144 interposed between adjacent slots 2143 each aligned with a corresponding pair of signal contacts 2011. The width of each of the portion 2144 in the lateral direction is greater than the width of the corresponding pair of signal contacts 2011. The openings 2143 are elongated, therefore, airflow can circulate through the openings 2143 on the upper ground plate 2140, the space between the upper ground plate 2140 and the lower ground plate 2141, and the openings 2143 on the lower ground plate 2141. thereby forming an air heat dissipation channel. The grooves 120 on the cover 12 and the openings 2143 on the upper ground plate 2140, the space between the upper ground plate 2140 and the lower ground plate 2141, the openings 2143 on the lower ground plate 2141, the space between the upper assembly 210 and the lower assembly 220, the openings 2143 on the lower assembly 220 that is the same as that on the upper assembly 210, the openings 240 of the separator 24 and the intermediate opening 111 on the main body 11 are in air communication. Therefore, the electrical connector 100 has an air heat dissipation channel as a whole.

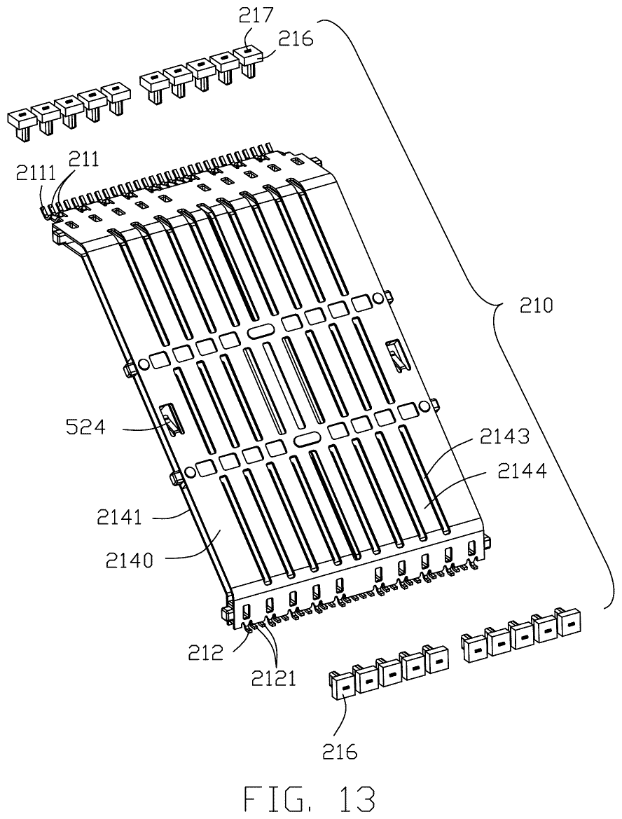

Referring specifically to FIGS. 13-15, the upper ground plate 2140 may integrally form a plurality of ground contacting portions 2111 and a plurality of ground mounting portions 2121 beside or between corresponding pairs of signal contacts 2011. As can be understood, the plurality of ground contacting portions and the plurality of ground mounting portions may equally well be formed on the lower ground plate 2141, or the upper ground plate 2140 may form some of the plurality of ground contacting portions or ground mounting portions while the lower ground plate 2141 may form the remaining ground contacting portions or ground mounting portions. In a similar manner, an upper ground plate and a lower ground plate of the lower assembly 220 may include integral ground contacting portions and/or ground mounting portions. The upper ground plate 2140 may include one or more fingers 524 for touching the lower ground plate 2141. The ground plate 2140 or 2141 may further include an overhanging feature for impedance control, such as front extensions 526 each situated between every two ground contacting portions 2111.

The insulator 213 extends transversely. In this embodiment shown, there are four pieces of insulators, namely, one at the horizontal section 2151, one at the vertical section 2152, and two at the inclined section 2153. The two insulators at the inclined section 2153 are connected together. The insulator 213 has posts 2131 and the ground plates 2140 and 2141 have positioning holes 2145. The insulator 213 has two opposite positioning ends 2130 for engaging with corresponding mounting holes 2300 of the pair of side plates 230. If desired, the positioning ends 2130 may be heat staked after securement in the mounting holes 2300. The number of the insulator 213 can be increased or decreased according to specific needs.

The conductive element 216 may be made of metals or other conductive materials. The conductive element 216 may be separately made and then mounted to the ground plates 2140 and 2141 or formed in situ, e.g., molded from conductive plastic material having a surface resistivity of about 0.1 Ω/square or having a bulk resistivity of about 0.02 Ω-cm. Of course, conductive plastic materials with surface resistivity greater than 0.1 Ω/square can also be used, or conductive plastic materials with bulk resistivity greater than 0.02 Ω-cm can be used. When using molded conductive element 216, after the ground plates 2140 and 2141 and the insulator 213 are assembled, the conductive element 216 is molded to electrically connect the upper ground plate 2140 and the lower ground plate 2141. The conductive element 216 can also be molded on the insulator 213 first, and then the upper ground plate 2140 and the lower ground plate 2141 may be assembled. When using separately made and mounted conductive element 216, the conductive member 216 can be assembled after the upper shielding plate 2140, the lower shielding plate sheet 2141 and the insulator 213 are assembled. The conductive element 216 and the insulator 213 may also be assembled first, and then assemble the upper ground plate 2140 and the lower ground plate 2141 and the conductive element 216 to be electrically connected.

In the embodiment shown, the conductive element 216 is separately made and then mounted to the ground plates 2140 and 2141 and the insulator 213. Specifically, the insulator 213 has holes 2132 and the ground plates 2140 and 2141 have holes 2142 aligned with the holes 2132. After the ground plates 2140 and 2141 are assembled to the insulator 213, the conductive element 216 extends through the holes 2142 of the upper ground plate 2140, the holes 2132 of the insulator 213, and the holes 2142 of the lower ground plate 2141. Each of the insulators 213 may be provided with holes 2132, or only some of the insulator 213 may be provided with the holes 2132. Specifically, in the present invention, the holes 2132 is provided on the insulator 213 located at the horizontal section 2151 and the vertical section 2152 to electrically connect the upper ground plate 2140 and the lower ground plate 2141 in an area close to the ground contacting portion 2111 and the ground mounting portions 2121. The insulator 213 is provided with a hole 2132 between each adjacent pair of signal contacts 2011.

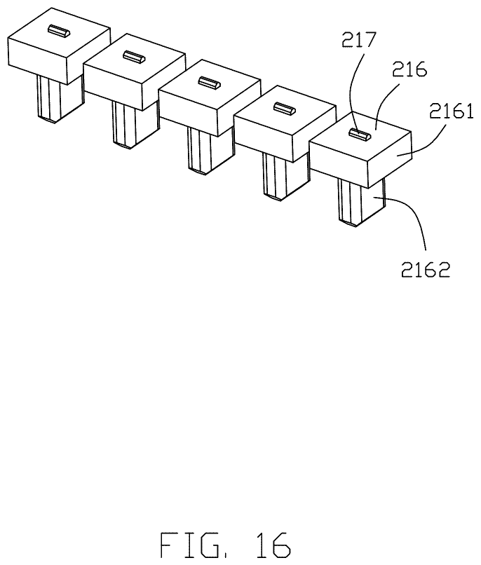

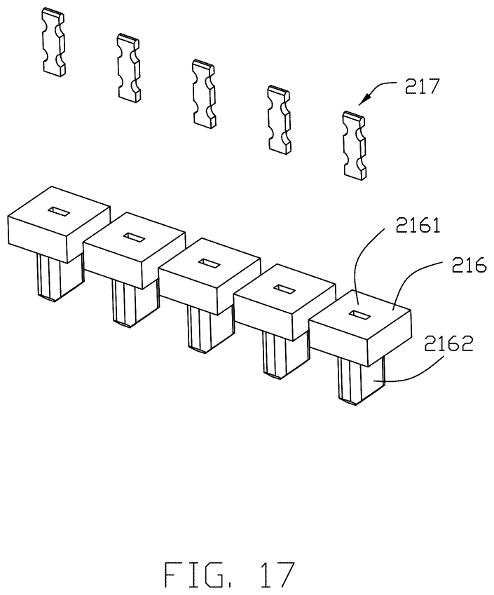

Referring specifically to FIGS. 16 and 17, the conductive element 216 is constructed of a plurality of separate conductive rivets. Each rivet has a base 2161 positioned outside the upper ground plate 2140 and an extension 2162 entering the hole 2142 of the upper ground plate 2140, the hole 2132 of the insulator 213, and the hole 2142 of the lower ground plate 2141. The lateral dimension of the base 2161 is larger than that of the extension 2162. The vertical dimension of the extension 2162 is larger than that of the base 2161, and the base 2161 is larger than the through hole 2142 on the upper ground plate 2140. The base 2161 is located outside the upper ground plate 2140, and the base 2161 stops at the upper ground plate 2140. The free end of the extension 2162 may extend beyond the lower ground plate 2141 and be heat staked. A metallic piece 217 may be present in each rivet after severing a carrier which originally connects to all the metallic pieces 217 molded with the separate rivets. The metal piece 217 extends through the base 2161 to the extension 2162 to enhance the strength of the conductive element 216. The metal piece 217 is not in direct mechanical contact with the upper ground plate 2140 and the lower ground plate 2141.

The lower assembly 220 may be similarly structured as the upper assembly 210.

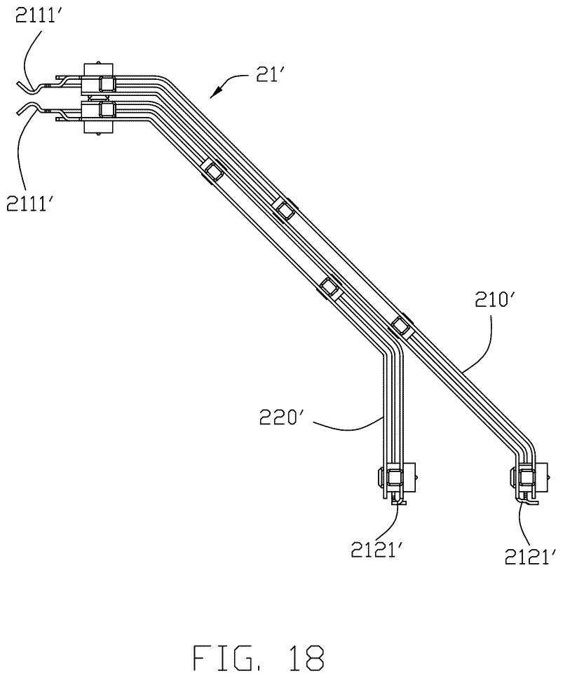

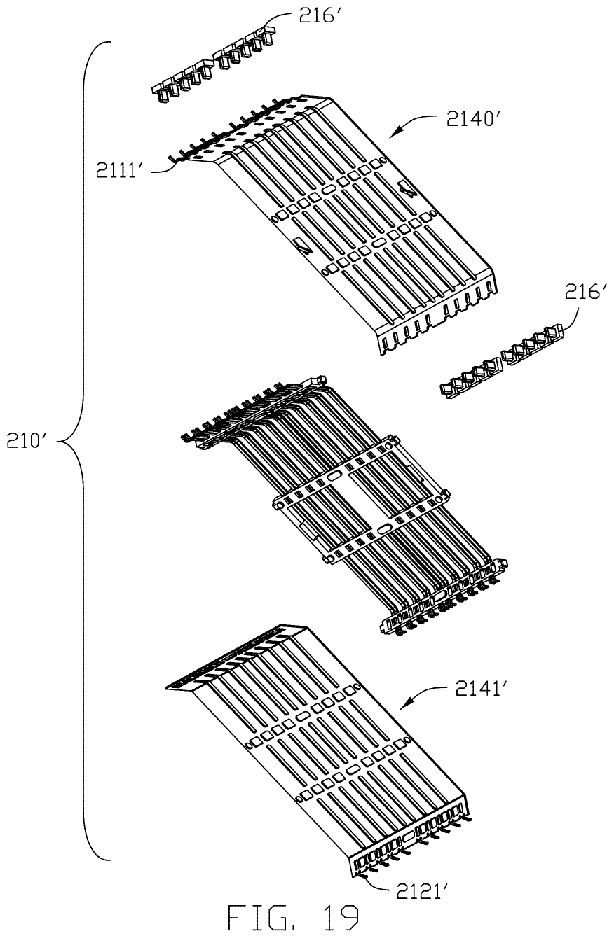

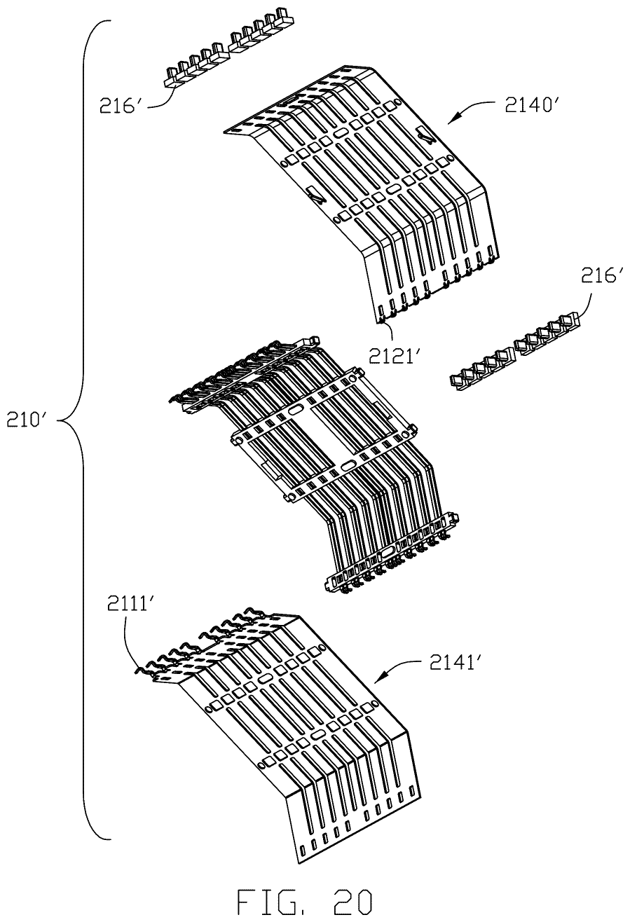

Referring to FIGS. 18-20, in a varied contact assembly 21′, for an upper assembly 210′, a plurality of ground contacting portions 2111′ are formed on one of an upper ground plate 2140′ and a lower ground plate 2141′ while a plurality of ground mounting portions 2121′ are formed on the other of the upper ground plate 2140′ and the lower ground plate 2141′. A lower assembly 220′ may be similarly designed as the upper assembly 210′.

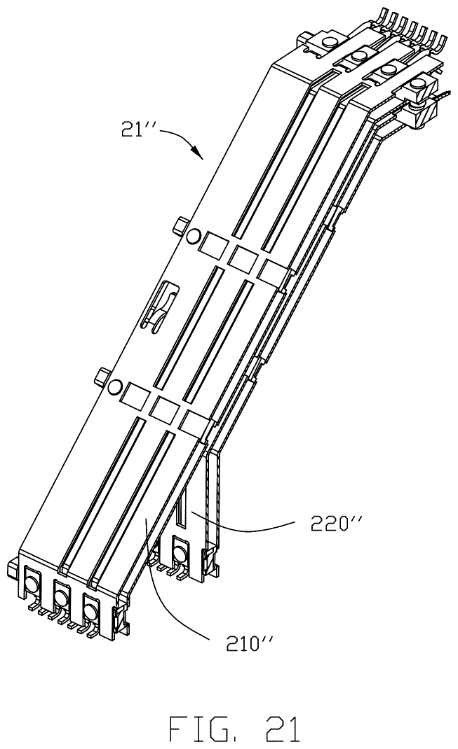

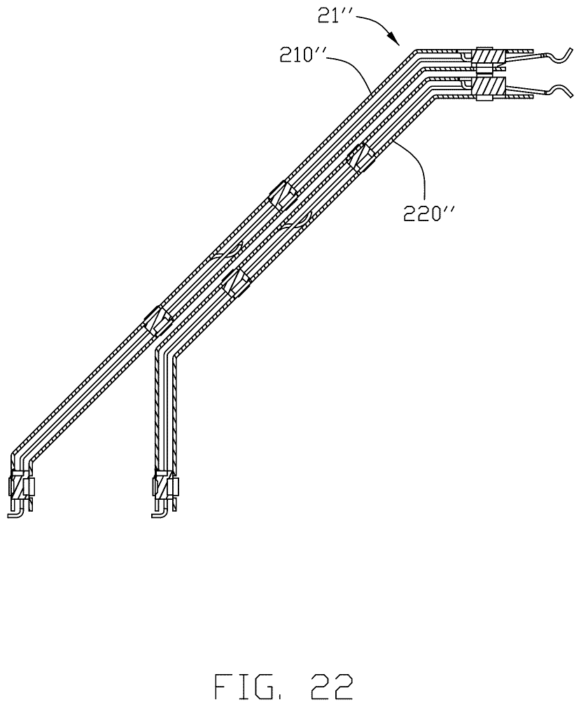

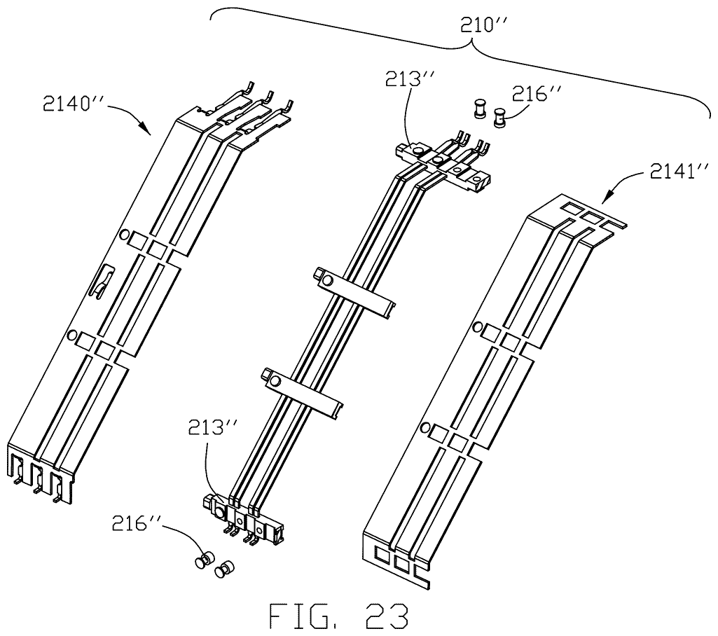

Referring to FIGS. 21-23, in another varied contact assembly 21″, for both an upper assembly 210″ and a lower assembly 220″, varied conductive plastic rivets 216″ are designed as molded with upper and lower ground plates 2140″ and 2141″ and an insulator 213″.

1. A contact assembly for an electrical connector, comprising:
a row of contacts having a plurality of contacting portions;
an insulator secured to the plurality of contacting portions;
an upper ground plate and a lower ground plate surrounding the row of contacts, at least one of the upper and lower ground plates integrally having a plurality of ground contacting portions aligned with the plurality of contacting portions of the row of contacts; and
a plurality of separate conductive rivets electrically connecting the upper and lower ground plates.

2. The contact assembly as claimed in claim 1, wherein:
the row of contacts has a plurality of mounting portions;
the insulator is secured to the plurality of mounting portions; and
at least one of the upper and lower ground plates integrally has a plurality of ground mounting portions aligned with the plurality of mounting portions of the row of contacts.

3. The contact assembly as claimed in claim 2, wherein the plurality of ground contacting portions are formed on one of the upper ground plate and the lower ground plate while a plurality of ground mounting portions are formed on the other of the upper ground plate and the lower ground plate.

4. The contact assembly as claimed in claim 2, wherein the plurality of ground contacting portions and the plurality of ground mounting portions is formed on the upper ground plate.

5. The contact assembly as claimed in claim 2, wherein the plurality of ground contacting portions and the plurality of ground mounting portions are formed on the lower ground plate.

6. The contact assembly as claimed in claim 2, wherein the upper ground plate forms some of the plurality of ground contacting portions or ground mounting portions while the lower ground plate forms the remaining ground contacting portions or ground mounting portions.

7. The contact assembly as claimed in claim 1, wherein the upper ground plate and the lower ground plate are equidistantly spaced from and surround the row of contacts to form a strip-line structure.

8. The contact assembly as claimed in claim 1, wherein the insulator has holes and the upper ground plate and the lower ground plate have holes aligned with the holes of the insulator, each rivet has a base positioned outside the upper ground plate and an extension entering the hole of the upper ground plate, the hole of the insulator, and the hole of the lower ground plate, and the free end of the extension extends beyond the lower ground plate and is heat staked.

9. The contact assembly as claimed in claim 1, further comprising a metallic piece present in each rivet after severing a carrier which originally connects to all the metallic pieces.

10. The contact assembly as claimed in claim 1, wherein the row of contacts includes signal contacts for differential pair signals, each of the upper ground plate and the lower ground plate has a plurality of openings for air circulation and plural portions interposed between adjacent openings and each aligned with a corresponding pair of signal contacts.

11. The contact assembly as claimed in claim 1, wherein each contact of the row of contacts has a contacting portion, a mounting portion, and an intermediate portion therebetween, the intermediate portion includes a horizontal section connected to the contacting portion, a vertical section connected to the mounting portion, and an inclined section between the horizontal section and the vertical section.

12. The contact assembly as claimed in claim 11, wherein there are four pieces of insulators, one at the horizontal section, one at the vertical section, and two at the inclined section, and the two insulators at the inclined section are connected together.

13. The contact assembly as claimed in claim 1, wherein each of the upper ground plate and the lower ground plate is generally planar and is a single piece.

14. The contact assembly as claimed in claim 1, wherein the upper ground plate and the lower ground plate in a lateral direction is greater than or equal to the outermost dimension of the first row of contacts in the lateral direction.

15. The contact assembly as claimed in claim 1, wherein the upper ground plate includes one or more fingers for touching the lower ground plate.

16. The contact assembly as claimed in claim 1, wherein the upper ground plate comprises an overhanging feature for impedance control, the overhanging feature comprises plural front extensions each situated between every two ground contacting portions.

17. The contact assembly as claimed in claim 1, wherein the conductive rivets are made of metals or other conductive materials.

18. The contact assembly as claimed in claim 1, wherein the conductive rivets are molded with the upper ground plate, the lower ground plate, and the insulator.

19. A contact assembly for an electrical connector, comprising:
a row of contacts, each of the contacts having a contacting portion;
an insulator secured to the row of contacts;
an upper ground plate and a lower ground plate surrounding the row of contacts, at least one of the upper and lower ground plates integrally forming a plurality of ground contacting portions aligned with the contacting portions of the row of contacts; and
a plurality of separate conductive rivets electrically connecting the upper and lower ground plates.

20. The contact assembly as claimed in claim 19, wherein:
each of the contacts has a mounting portion;
at least one of the upper and lower ground plates integrally has a plurality of ground mounting portions aligned with the mounting portions of the row of contacts.
